(19) United States
(12) Patent Application Publication
(10) Pub. No.: US 2010/0312706 A1
(43) Pub. Date: Dec. 9, 2010

(54) NETWORK CENTRIC SYSTEM AND METHOD TO ENABLE TRACKING OF CONSUMER BEHAVIOR AND ACTIVITY

(76) Inventors: Jacques Combet, Levallois Perret (FR); Gérard Hermet, Paris (FR)

Correspondence Address: Brian K. Dinicola;GfK Holding Inc, 5th Floor, 75 Ninth Avenue, New York City, NY, 10011, US

(21) Appl. No.: 12/763,791

(22) Filed: Apr. 20, 2010

Related U.S. Application Data
(60) Provisional application No. 61/185,319, filed on Jun. 9, 2009.

(51) Int. Cl. G06Q 10/00; G06F 15/16; H04L 9/08; G06Q 30/00

(52) U.S. Cl. 705/50; 709/229; 380/278; 705/1.1

(57) ABSTRACT

A method for collecting Internet and e-commerce data accessed via messaging devices such as mobile terminals comprises monitoring packet traffic in a communication system providing communication services to the messaging devices and extracting network data from packets associated with respective device users. The portion of extracted network data from which a user's identity might otherwise be determined is encrypted, creating an anonymized, unique identifier correlated to network access data extracted from any packet traffic applicable to that user. Network access data associated with each user is distinguishable from network access data associated with all other users on the basis of the unique identifier. A third party granted access to the anonymized network access data, associated with identifiably unique but anonymous users of the communication system, may retrieve and store the data in a database for analysis. Anonymized network access data associated with those users electing to become voluntary panelists is correlated, solely on the basis of the anonymized unique identifier, to socio-demographic data furnished by such panelists.

### REFERENCE TO RELATED APPLICATIONS

This application claims the benefit of U.S. Provisional Application No. 61/185,319, filed Jun. 9, 2009 and entitled NETWORK INTELLIGENCE COMPUTER SYSTEM AND METHOD TO TRACK CONSUMER BEHAVIOR AND ACTIVITY ON THE INTERNET, the entire contents of which are herein incorporated by reference.

### BACKGROUND OF THE INVENTION

1. Field of the Invention

The present invention relates generally to methods and systems for monitoring traffic that traverses a communication network and, more particularly, the subject matter described herein relates to methods and systems for collecting and analyzing data extracted from internet traffic.

2. Description of the Related Art

The Internet is now a favored method of accessing information, communicating, advertising and shopping for and purchasing goods, with the sale of Internet services continuing to grow at an amazing rate. This rapid growth has dramatically impacted the telecommunications and media industries—both from the standpoint of an opportunity to realize new business and as a concern due to the potential loss of traditional revenue sources. The explosive growth in personal computers and mobile terminal devices such as smart phones and personal data assistant (PDA) devices has cultivated a need for companies collect and analyze many terabytes of data in order to arrive at the best way to service their customers, advertise new products, and even judge the effectiveness of marketing programs, advertising campaigns and sponsorship arrangements.

Companies have designed many browsers and millions of web pages to access, retrieve and utilize internet traffic information. Service providers, as well, have had to adapt to these developments. Mobile operators, for example, had at one time very tight control on the content that was being accessed on their networks and used to limit user access to a “walled garden” or “on deck content”. This was done for two reasons: to optimize their network for well-understood content, and to control user experience. With the advent of more open devices and faster networks, the next trend in the mobile community was to access ‘off-deck’ or ‘off-portal’ content, which is content generally available on the Internet at large and not pre-selected content hosted by the operator. This movement was initially somewhat troubling to mobile network service providers for two reasons. First, service providers had very limited visibility in the usage of off-deck content and hence they did not have the ability to design and optimize their networks for this usage. Further, they also lacked the ability to control what their users accessed and hence they feared becoming ‘dumb pipes’ and not participating in the whole movement towards advertising and monetizing Internet content.

With the advent of deep packet inspection (DPI) technology, both mobile and fixed based service providers have gained the ability to collect data regarding the traffic that traverses their networks or a communication link within their network. For example, data collection devices now often use taps on communication links to copy packets that traverse the communication links. The copied packets are forwarded to an application for processing, permitting the service provider to analyze the types of applications, traffic flows and utilization patterns and thereby ensure that their networks are adequately configured to handle the different kinds of traffic and their rates. An example of a system employing such inspection and analytical techniques in a communication network is described in U.S. Published Application No. 2009/0052454 filed on Aug. 4, 2008 by Pourcher et. al and entitled “METHODS, SYSTEMS, AND COMPUTER READABLE MEDIA FOR COLLECTING DATA FROM NETWORK TRAFFIC TRAVERSING HIGH SPEED INTERNET PROTOCOL (IP) COMMUNICATION LINKS.”

An approach similar to that of Pourcher et al. is employed by various vendors of solutions based upon Deep Packet Inspection to capture application and bandwidth information. Such information helps answer questions such as—what fraction of users are running a given application, or what fraction of bandwidth is used by a given application, but the approaches used do not allow for storage and analytics on the data. Instead, such information is of primary and singular interest to the service provider seeking to optimally configure its network.

An approach used by traditional Web Analytics vendors (e.g. Omniture) relates to using logs on the protocol or application (e.g. HTTP). The traditional web approach does not work well for mobile applications for a number of reasons. First, this is restricted to a single application, which is HTTP. Mobile analytics requires a view across applications such as SMS, WAP, Downloads, Instant Messaging, etc. Further, these applications don't necessarily generate logs and also log-based reports tend to be time-delayed. Web analytics tend to rely on client side support such as JavaScript, cookies, etc. which are not available universally on mobile devices. Finally, web techniques do not provide any way of tracking the activity of unique, individual users. An IP address, for example, may be assigned using a dynamic host control protocol (DHCP) process and thereby change each time a user initiates access to the internet.

Recognizing that mobile terminal devices are highly personal, it has been proposed to use DPI and mobile network database records to compile specific information about mobile device users such as their location, usage patterns, etc. in order to generate very targeted content and advertising. See, for example, published U.S. Patent Application 2009/0138593 filed by Kalavade on Nov. 26, 2008 and entitled “SYSTEM AND METHOD FOR COLLECTING, REPORTING AND ANALYZING DATA ON APPLICATION-LEVEL ACTIVITY AND OTHER USER-INFORMATION ON A MOBILE DATA NETWORK”, which is expressly incorporated herein in it is entirety. In the system disclosed by Kalavade, traffic accessed by mobile terminal users is subjected to deep packet inspection and the extracted data is processed and stored in a database. Using the mobile service identification service number (MSISDN), which is uniquely assigned to each user by the network operator, a database operator can associate extracted data with personal information known or available to the network operator (e.g., the user's name, address, service plan, and terminal device). Kalavade cites the benefits of such a system to both the mobile network operator—which can construct and maintain an architecture best suited for the types of traffic being carried and expected in the future—and to web content providers, which can use specific knowledge about a particular current and past user's browsing activity and/or location to direct specific advertising messages at that user. Unfortunately, the maintenance and use of such personalized information in this manner—particularly with the view towards directing targeted advertising at selected network subscribers—is considered offensive and an invasion of privacy by a very large percentage of the consuming public.

A continuing need therefore exists for a system and method for constructing a warehouse of knowledge capable of answering questions—like how, when, why and what socio-demographically identifiable groups of mobile network subscribers are using their mobile terminal devices to access the internet—in a way that makes meaningful data available to advertisers, content providers and network operators while at the same protecting the privacy of the individuals from whom the data is collected.

A further need exists for a system and method of tracking, on an anonymous basis, all phases of online purchase decision by demographically identifiable groups—from the initial moment of exposure to an advertising message, information gathering via web browsing activity, to the shopping cart “checkout”.

Yet another need exists for a system and method for aggregating web access data by unique subscribers and presenting, via a web-portal, reports of sufficient granularity to reflect patterns of web site browsing and shopping activity by socio-demographically classifiable groups.

### SUMMARY OF THE INVENTION

The aforementioned needs are addressed, and an advance is made in the art, by a method for collecting, processing and analyzing Internet and e-commerce data accessed by users of messaging devices such, for example, as users of mobile terminals like smart phones, 3G telephones, and personal digital assistants (PDAs). The method includes a step of receiving raw network access data extracted from packetized traffic traversing a network element of a communication system. In addition to the payload, each IP packet carries the control information that allows it to get to its destination—an indication of its source, an indication of its destination, something that tells the network how many packets that the data being transmitted has been broken into, a time stamp, a number representative of the packet's order in a sequence, and other information. Data extracted from the payload portion of a packet or set of packets corresponding to internet browsing activity will include such information as the URL of a web page or website visited. As used herein, the term “raw network access data” is intended to include not just the aforementioned browsing activity information but also the date and time of such visit(s), the type and/or model of messaging device used, and the user's location. The term network access data is intended to encompass both raw network access data and data derived therefrom. For example, it is possible to compute the duration of a web page visit from the time stamp of the corresponding packet(s). Packets corresponding to browsing activity by a user of a mobile terminal typically include a unique identifier such as an MSISDN number.

A portion of the extracted network access data is encrypted to anonymize the received network access data, obscuring information from which messaging device users' identities or data that could be used to obtain their identities might otherwise be determined. In accordance with one aspect of the invention, the encrypted portion constitutes a unique “anonymizing” identifier that can be correlated to unencrypted network access data extracted from those packets associated with a corresponding user. This “anonymizing” process allows tracked network access activity of any individual user to be differentiated from the tracked network access activity of all other users on a completely anonymous basis—that is, without referencing any personal identity information (name, address, telephone number, account number, etc) of the users. As utilized herein, then, “anonymized network access data” refers to unencrypted network access data that can be unambiguously correlated to a singular user without reference to either the identity of the user or to any information from which the identity of the user might be determined.

A third party accessing only the anonymized data can not target unsolicited advertising at individual users, preserving the privacy expectations of the network operator's subscribers. Advantageously, however, such a third party can easily aggregate some or all of these subscribers to form a representative sample of all users in a given territory or region (country, state, county, etc) and/or all users belonging to an identifiable socio-demographic group (age, gender, etc). Any aspect of the anonymously tracked network access behavior—the types of web sites and web pages the users visit, their internet browsing histories and itineraries, and their respective online shopping experiences—can be tracked and analyzed to provide insight that is useful and meaningful to advertisers, content developers and providers, merchants, and suppliers.

By way of illustrative example, an MSISDN identifier extracted from a packet traversing the network element of a mobile communication network is encrypted in accordance with an embodiment of the invention using a cryptographic hash function in combination with a secret key. The encrypted MSISDN identifier thus becomes an anonymized, unique identifier which identifies any other network access data extracted from packets bearing the same user's MSISDN. Such network access activity as the websites and web pages visited by a mobile terminal user can be tracked by the operator, or by a third party authorized by the operator and/or the individual messaging device users, without reference to the name, phone number, or any other identifying indicia of the users. This arrangement ensures the privacy of the user, while still making available a great volume of internet browsing information from which patterns of activity can be monitored and reported.

Network access data anonymized in the above-described manner, once received, is processed for analysis. Anonymized network access data associated with any messaging device user is distinguishable, on the basis of the anonymized identifier, from anonymized network access data associated with all other messaging device user. The processed data is then analyzed to create reports. By way of illustrative example, the internet browsing activity of many users can be aggregated to generate reports of how many uniquely identifiable users are visiting a particular web page or website during a given interval (hour, day, week, etc), the identities of the most common websites or web pages from which such visitors were directed, and the identifiers of the most common web sites or web pages to which such visitors were subsequently directed. Other data derived from the anonymized network access data includes the average amount of time a group of uniquely identifiable users visited a given page.

Still other capabilities of the present invention may be utilized by referencing certain available socio-demographic data while analyzing the processed network access data. Socio-demographic information on users can be collected from (a) a customer relationship management (CRM) database maintained by the network operator; (b) directly from individual users themselves and/or (c) from one or more consumer panels consisting of users who volunteer to provide, among other things, the socio-demographic information. The first two options may be executed by either the operator or a third party. In all cases, however, the socio-demographic profile of each user preferably correlates to the unique identifier that was assigned to that user when the extracted network access data of that user was anonymized.

In a first illustrative embodiment, the network operator performs a step of processing and, optionally, a step of analyzing the anonymized network data, by making reference to socio-demographic information collected from the network operator's own customer relationship (CRM) database. Such a database will typically include such information as each user's name, address, and telephone number (MSISDN), but may also be augmented to include such socio-demographic data elements as the user's age, gender, native language, individual and/or household income, and the like. To allow the socio-demographic profile of each anonymized user to be distinguished from every other anonymized user when, for example, processing and/or analyzing the anonymized network access data for analysis, and to protect the privacy of the users when the profiles are shared with a third party (e.g., for use in processing and/or analyzing the anonymized network access data), it is necessary to maintain an association between each user's socio-demographic profile and anonymized network access data. It is possible to develop a second set of unique, anonymous identifiers and maintain a table for correlating these to the unique identifiers used to anonymize the extracted network access data. However, it is far more convenient to use the same unique identifier to denote both the extracted network access data and the socio-demographic profiles. This is achieved, for example, by taking the element of the user's socio-demographic profile which was extracted and encrypted to anonymize the network access data (e.g., the user's telephone number or MSISDN) and subjecting it to the same encryption process using the identical secret key.

In a second illustrative embodiment of the invention, a party other than the network operator(s) (i.e., a “third party”) performs the steps of processing and analyzing raw network data extracted from packets and anonymized in accordance with the teachings of the present invention. The processing and/or analysis can be enhanced by referring to socio-demographic data elements that have been collected from a source other than the network operator's CRM database. For example, the third party may build its own socio-demographic profiles from data elements collected directly from those network subscribers who opt-in to the monitoring of their network access activity and to the analysis of the same based on socio-demographic factors. The third party may optionally recruit some of the operator's subscribers into one or more consumer research panels, or these subscribers may already be members of a panel, whereby supplemental means are employed to gather additional information from these recruited subscribers (and from other members of the panel who are not subscribers to the communication network). Such panels are typically constituted in such a way as to be representative of a given market or “universe” in statistical terms, and thus can be useful for “calibrating” the data obtained in accordance with monitoring, processing and analyzing techniques of the present invention.

Raw network access data extracted by the network operator (or by equipment hosted by the network operator) is anonymized before it is sent to/received by the third party. In accordance with this second illustrative embodiment, then, a mechanism is needed to enable the third party to correlate the socio-demographic profile (or data elements thereof) of a specific opting-in or recruited user to the appropriate anonymized network access data. One such mechanism is to obtain from the operator a unique identifier computed using the same encryption algorithm and secret key described in connection with the first illustrative embodiment.

An exemplary, automated process for providing the third party with access to an anonymized, unique identifier includes receiving at operator premises equipment a request from the third party. The request specifies information from which the operator can ascertain the identity of the user(s) for which an anonymized, unique identifier is requested, authenticating the third party using a conventional log-in process, and returning the anonymized, unique identifier(s) to the third party requester. In accordance with an illustrative embodiment, the information included in the third party request comprises the element of the user's socio-demographic data which was extracted and encrypted by the operator during the network access data anonymization process. In response to receiving an authenticated request, a network operator's interface server performs the anonymization and returns the requested anonymized, unique identifiers to the third party. The third party is then able to make an association between the elements of anonymized socio-demographic data it has gathered from its panelists and the anonymized network access data it has obtained from one or more network operators.

With reference to both socio-demographic data and the anonymized network access data, it is possible to detect patterns and trends in web site/web page visitation by groups of users sharing one or more socio-demographic attributes (age, gender etc). Thus, it is possible to identify not only the web pages and web sites visited by all messaging device users, but also break down the total number of visits by age bracket, gender, geographic region.

Anonymized network access data associated with any messaging device user is distinguishable, on the basis of the anonymized identifier, from anonymized network access data associated with all other messaging device user. For purposes of mobile communication networks, each user is deemed to be unique (and therefore distinguishable from other users), as long as the user has the same assigned MSISDN and remains a subscriber of the same operator. These criteria change rarely enough that they impart a high degree of confidence that the browsing behavior attributable to a given device corresponds to a single, unique person rather than merely to one of a group of people. Together with these reliable indicia of uniqueness, a counter mechanism may be employed to avoid multiple counting of the same visitor to a given website, webpage, or a specific banner advertisement.

The processed behavioral and/or socio-demographic data is analyzed to create reports. By way of illustrative example, the internet browsing activity of many users can be aggregated to generate reports of how many uniquely identifiable users are visiting a particular web page or website during a given interval (hour, day, week, etc), the identities of the most common websites or web pages from which such visitors were directed, and the identifiers of the most common web sites or web pages to which such visitors were subsequently directed. Other data derived from the anonymized network access data includes the average amount of time a group of uniquely identifiable users visited a given page.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1A is a block diagram depicting a system for performing anonymized collection of socio-demographic data from different types of communication networks in accordance with the teachings of the present invention, at least one of the communication networks being mobile communication network providing internet access to users of mobile network terminals;

FIG. 1B is a block diagram showing the functional elements of a platform and flow system for storing, processing, and analyzing the anonymized data collected from at least one mobile communication network, and providing reports generated using the same in accordance with the present invention;

FIG. 1C is a block schematic diagram illustrating an arrangement of databases and firewalls for controlling the exchange of information between one or more communication networks and the anonymized data collection and analysis platform;

FIG. 2A is a block diagram depicting in greater detail a system for performing the anonymized collection and analysis of internet access activity by subscribers of a mobile communication network;

FIG. 2B is a block diagram depicting a system for anonymizing both extracted internet access activity and socio-demographic data associated with respective messaging device users and for allowing such anonymized data to be retrieved, processed and analyzed by a third party, in accordance with a first illustrative embodiment of the present invention;

FIG. 2C is a block diagram depicting a system for anonymizing extracted internet access activity associated with respective messaging device users and for allowing such anonymized data to be retrieved, processed and analyzed by a third party with reference to socio demographic data collected independently from voluntary panelists selected from among the messaging devices users, in accordance with a second illustrative embodiment of the present invention;

FIG. 3 is a block diagram depicting the assignment of a unique identifier that allows internet access activity by mobile network subscribers to be derived and tracked—on an anonymous basis—and then aggregated based on, for example, one or more specifiable socio-demographic characteristics;

FIG. 4A is a flow chart illustrating an exemplary process for collecting, extracting, correlating and storing anonymized network access data (including, for example, web sites and/or web pages visited by users of messaging devices) and for enabling a third party to retrieve such anonymized access data from a communication network operator for further processing and analysis in accordance with an illustrative embodiment of the present invention;

FIG. 4B is a flow chart illustrating an exemplary process for collecting, extracting, correlating and storing anonymized network access data, as well as socio-demographic data, associated with respective users of messaging devices, and for enabling a third party to retrieve such anonymized access and data from a communication network operator for further processing and analysis in accordance with a modified embodiment of the present invention;

FIG. 4C is a flow chart illustrating in more specific detail an illustrative process for enabling a third party to retrieve anonymized socio-demographic data from a communication network operator, for use in connection with processing and analysis of retrieved anonymized network access data associated with users of messaging devices.

FIG. 4D is a flow chart illustrating an exemplary process for retrieving, from at least one communication network operator, anonymized network access data representative of internet access activity associated with messaging device users and for correlating such anonymized network access data with socio-demographic data independently acquired from voluntary panelists;

FIG. 5 is a block diagram illustrating the tracking of the various phases comprising an online shopping experience, from brand awareness to shopping cart checkout, which can be tracked and analyzed in accordance with an aspect of the present invention to measure, for example, the time distance between creation of brand awareness and commencement of the purchasing phase (basket step) per product or service category and/or per brand, as well as to measure trends over time;

FIG. 6 is a block diagram depicting the categorization of websites in accordance with a further illustrative aspect of the present invention, the categorization serving as a preliminary step to a form of internet access activity aggregation that makes possible, for example, the reporting and analysis of general trends applicable to one or more specifiable socio-demographic groups;

FIG. 7 is a graphical depiction, in tabular form, of an excerpt taken from the industry and category list scheme employed in the website categorization process depicted in FIG. 6;

FIG. 8 is a graphical depiction, in tabular form, of an illustrative form of website categorization that correlates URLs from an exemplary domain to an industry and category;

FIG. 9 is a graphical depiction, in a tabular form, of a hierarchical form of website categorization in accordance with an illustrative aspect of the present invention;

FIG. 10 is a graph depicting an illustrative distribution of discrete domain groups visited by unique subscribers of at least one communication network on a specified date, the respective share of each visited domain group as a percentage of the overall visited domain groups being shown in descending order;

FIG. 11 is a graph depicting, during each hour of a specified day, an illustrative number of unique visitors to a specified website;

FIG. 12 is a graph depicting the same information as FIG. 11, only with each hour broken down into quarter-hour increments for enhanced granularity;

FIG. 13 is a graph depicting, for the same website specified in FIGS. 11 and 12 and for each hour of the same specified day, the number of unique visitors;

FIG. 14 is a graph depicting, during each hour of a specified day, the average duration of each visit by unique subscribers to a specified website; and

FIG. 15 is a graph depicting, during each hour of a specified day, the average number of a specified web page was visited by unique subscribers.

### DETAILED DESCRIPTION OF EMBODIMENTS OF THE INVENTION

The present invention will become more fully understood from the detailed description given hereinbelow and the accompanying drawings which are given by way of illustration only, and thus, are not limits of the present invention, and wherein:

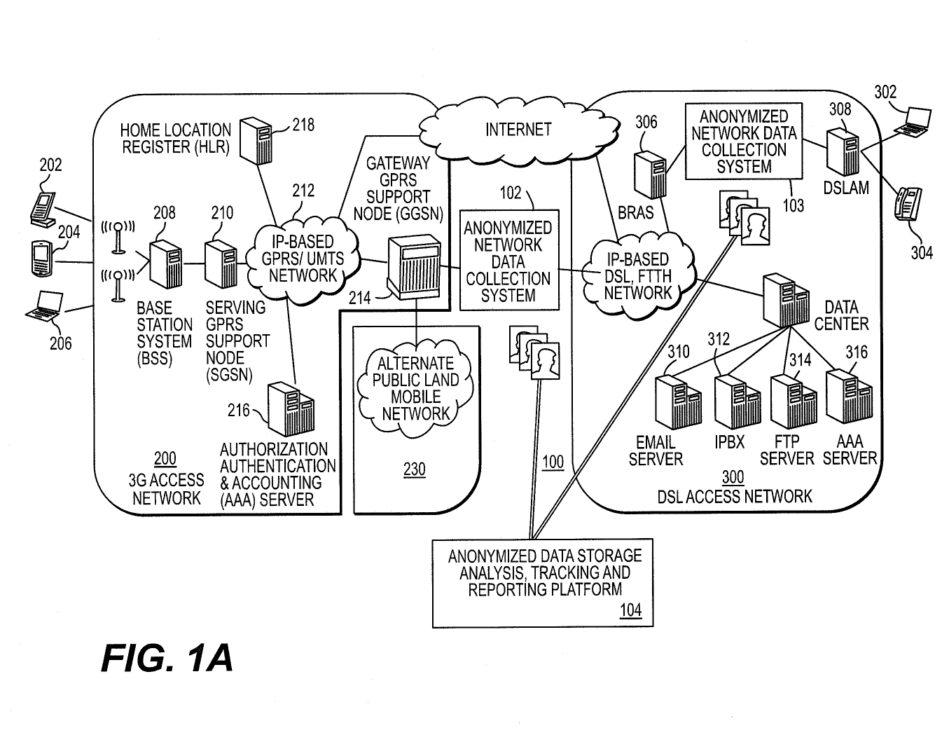

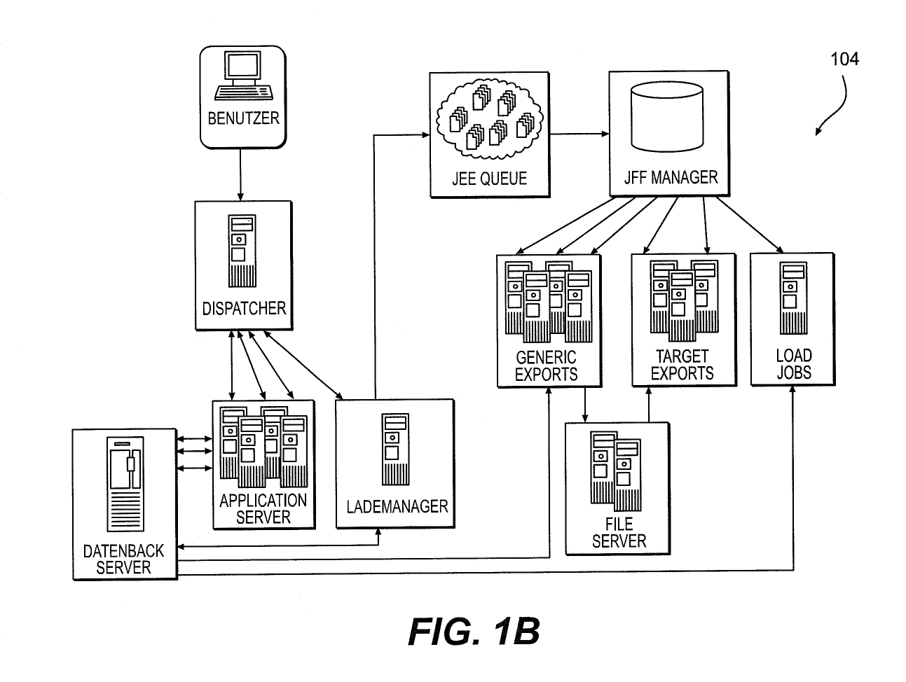

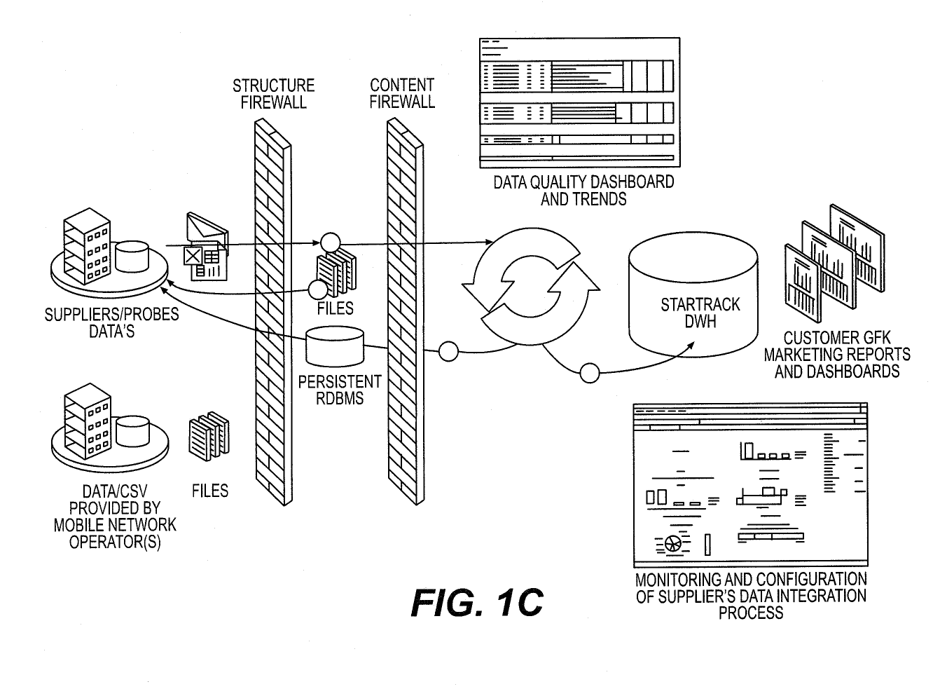

FIG. 1A is a block diagram depicting a system for performing anonymized profiling of internet traffic and usage in accordance with the teachings of the present invention;

FIG. 1B is a block diagram showing the functional elements of a platform and flow system for storing, processing, and analyzing the anonymized data, and providing reports generated using the same in accordance with the present invention;

FIG. 1C is a block schematic diagram illustrating an arrangement of databases and firewalls for controlling the exchange of information between one or more communication networks and the anonymized data collection and analysis platform;

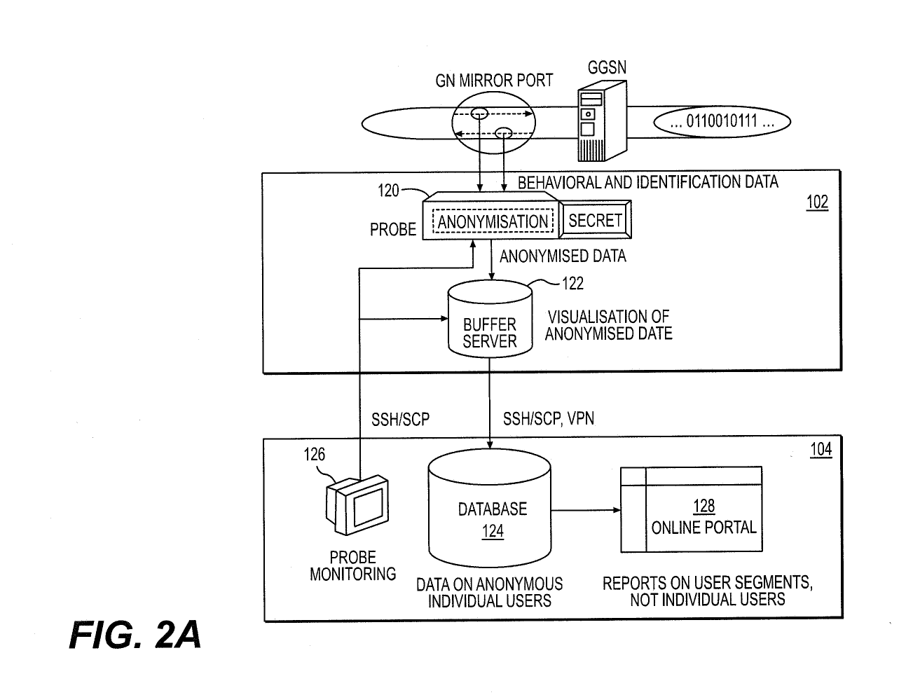

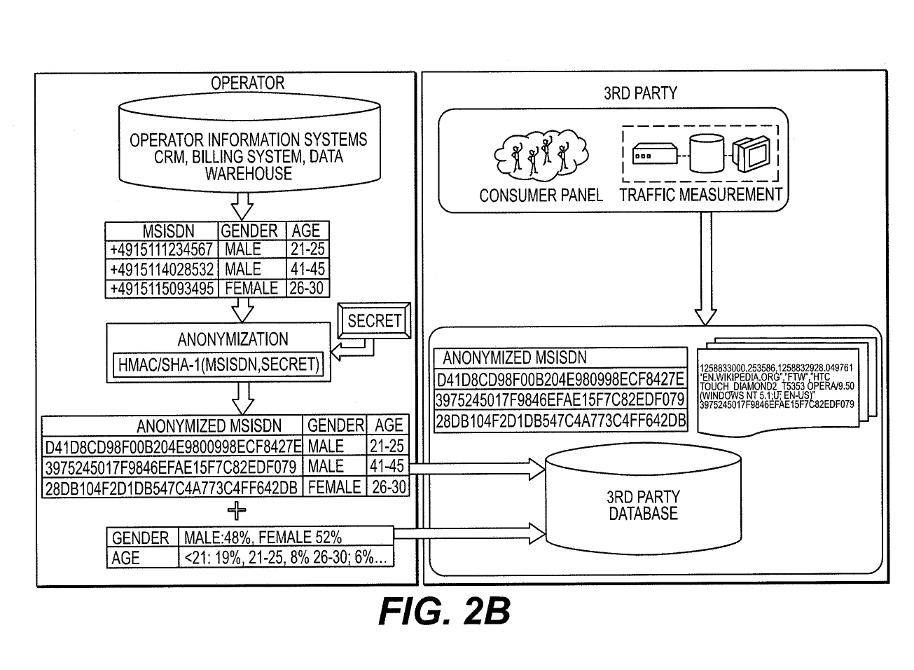

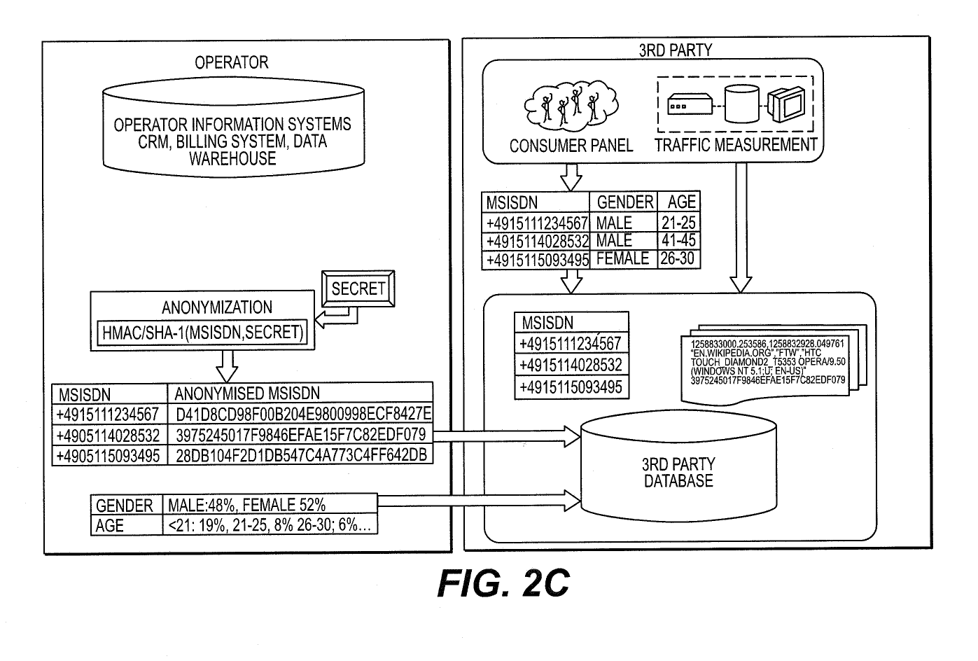

FIG. 2A is a block diagram depicting in greater detail a system for performing the anonymized collection and analysis of internet access activity by subscribers of a communication network;

FIG. 2B is a block diagram depicting a system for anonymizing both extracted internet access activity and socio-demographic data associated with respective messaging device users and for allowing such anonymized data to be retrieved, processed and analyzed by a third party, in accordance with a first illustrative embodiment of the present invention;

FIG. 2C is a block diagram depicting a system for anonymizing extracted internet access activity associated with respective messaging device users and for allowing such anonymized data to be retrieved, processed and analyzed by a third party with reference to socio demographic data collected independently from voluntary panelists selected from among the messaging devices users, in accordance with a second illustrative embodiment of the present invention;

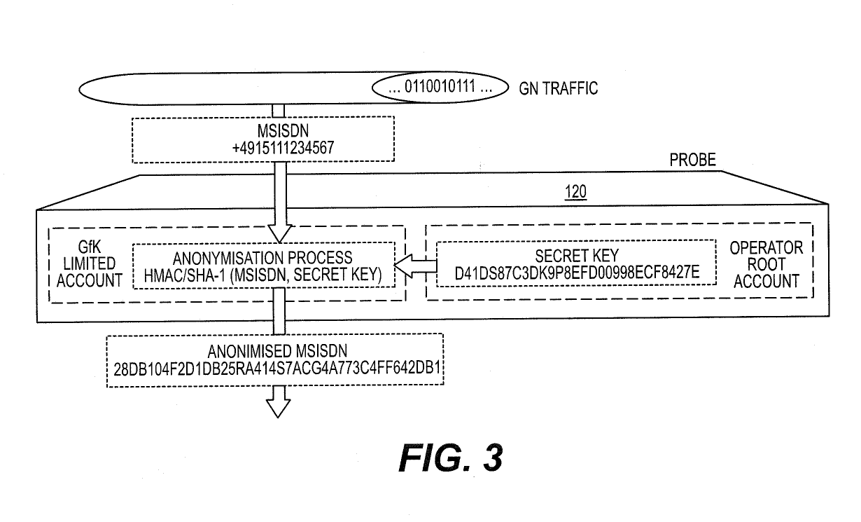

FIG. 3 is a block diagram depicting the assignment of a unique identifier that allows internet access activity by mobile network subscribers to be derived and tracked—on an anonymous basis—and then aggregated based on, for example, one or more specifiable socio-demographic characteristics;

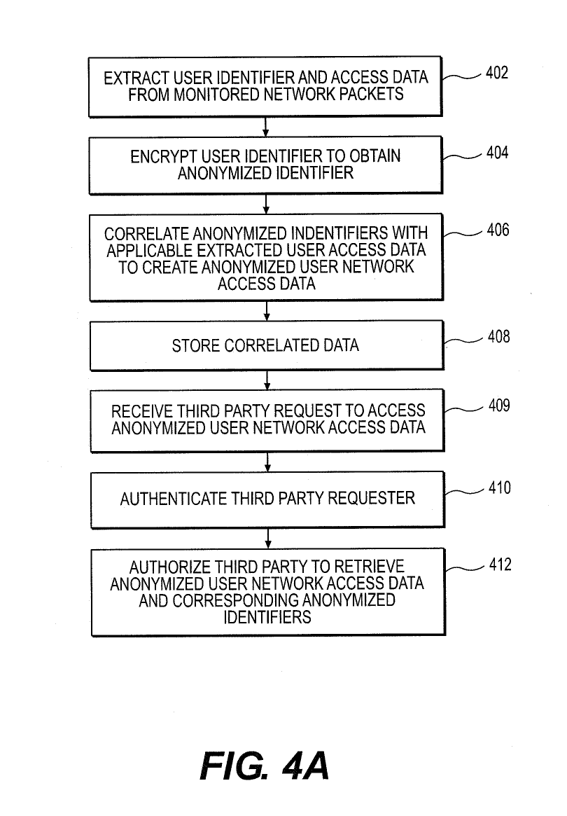

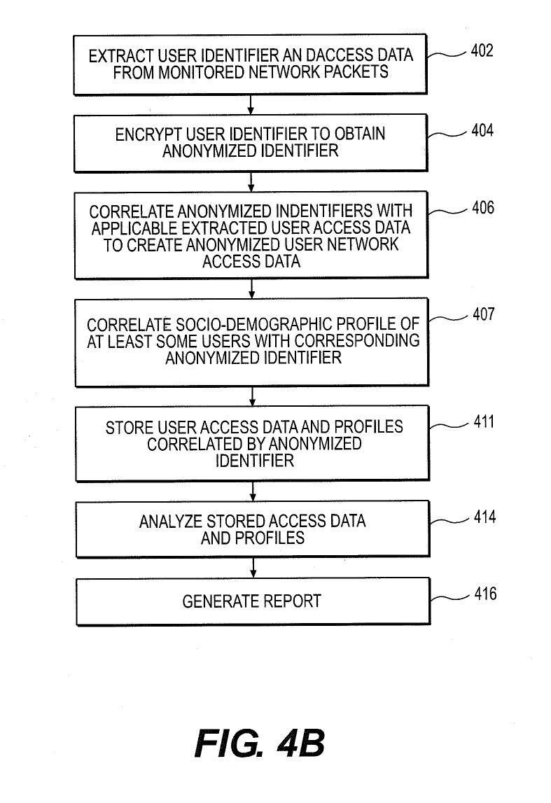

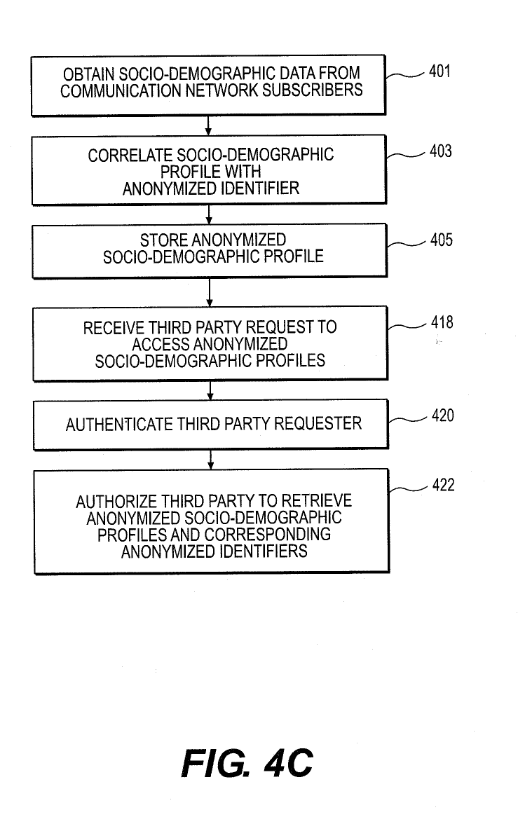

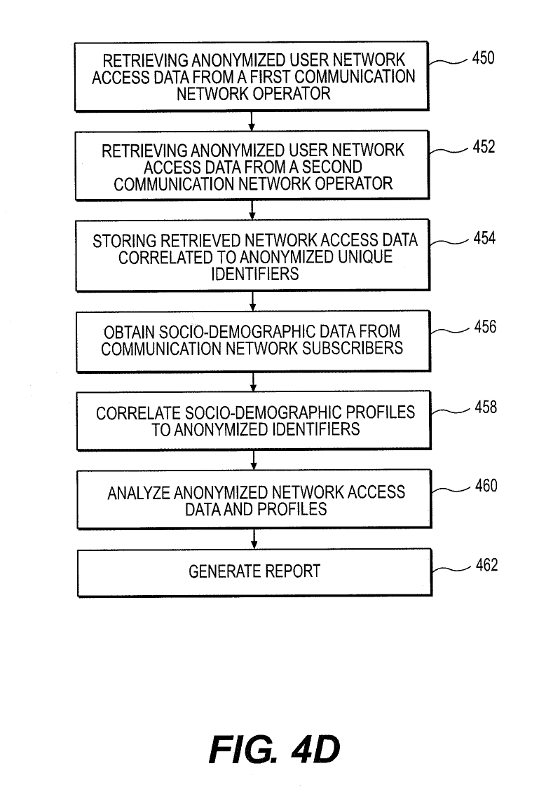

FIG. 4A is a flow chart illustrating an exemplary process for collecting, extracting, correlating and storing anonymized network access data (including, for example, web sites and/or web pages visited by users of messaging devices) and for enabling a third party to retrieve such anonymized access data from a communication network operator for further processing and analysis in accordance with an illustrative embodiment of the present invention;

FIG. 4B is a flow chart illustrating an exemplary process for collecting, extracting, correlating and storing anonymized network access data, as well as socio-demographic data, associated with respective users of messaging devices, and for enabling a third party to retrieve such anonymized access and data from a communication network operator for further processing and analysis in accordance with a modified embodiment of the present invention;

FIG. 4C is a flow chart illustrating in more specific detail an illustrative process for enabling a third party to retrieve anonymized socio-demographic data from a communication network operator, for use in connection with processing and analysis of retrieved anonymized network access data associated with users of messaging devices.

FIG. 4D is a flow chart illustrating an exemplary process for retrieving, from at least one communication network operator, anonymized network access data representative of internet access activity associated with messaging device users and for correlating such anonymized network access data with socio-demographic data independently acquired from voluntary panelists;

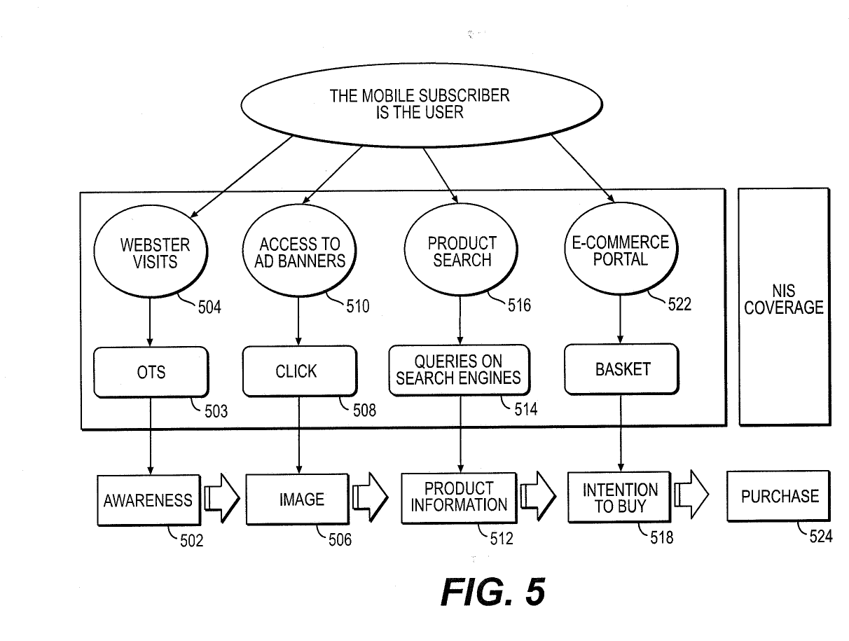

FIG. 5 is a block diagram illustrating the tracking of the various phases comprising an online shopping experience, from brand awareness to shopping cart checkout, which can be tracked and analyzed in accordance with an aspect of the present invention to measure, for example, the time distance between creation of brand awareness and commencement of the purchasing phase (basket step) per product or service category and/or per brand, as well as to measure trends over time;

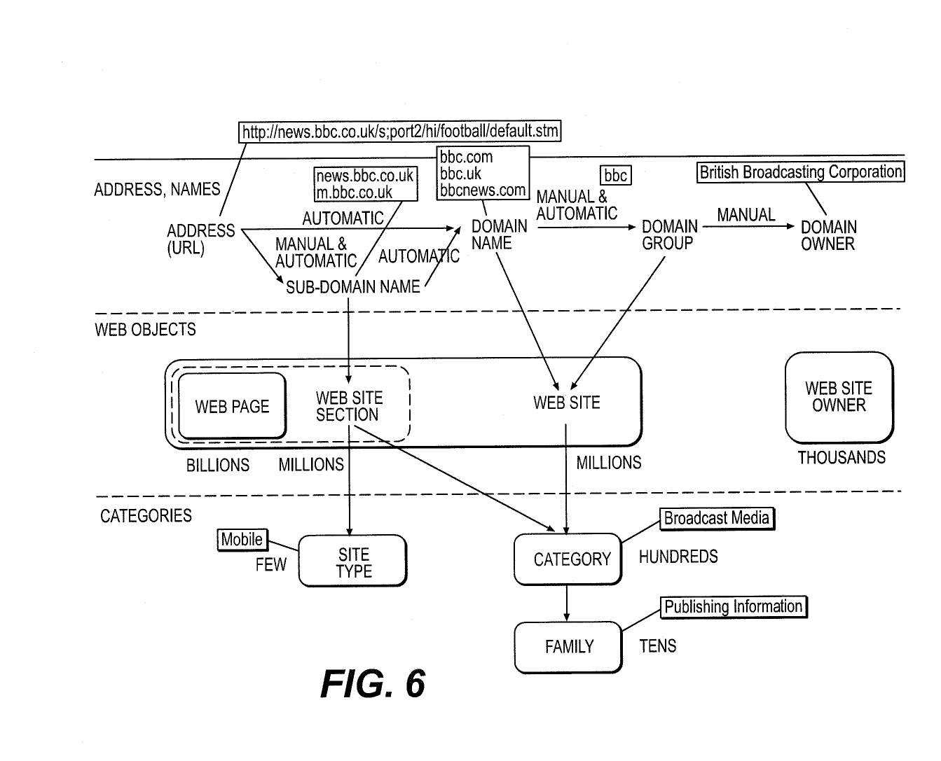

FIG. 6 is a block diagram depicting the categorization of websites in accordance with a further illustrative aspect of the present invention, the categorization serving as a preliminary step to a form of internet access activity aggregation that makes possible, for example, the reporting and analysis of general trends applicable to one or more specifiable socio-demographic groups;

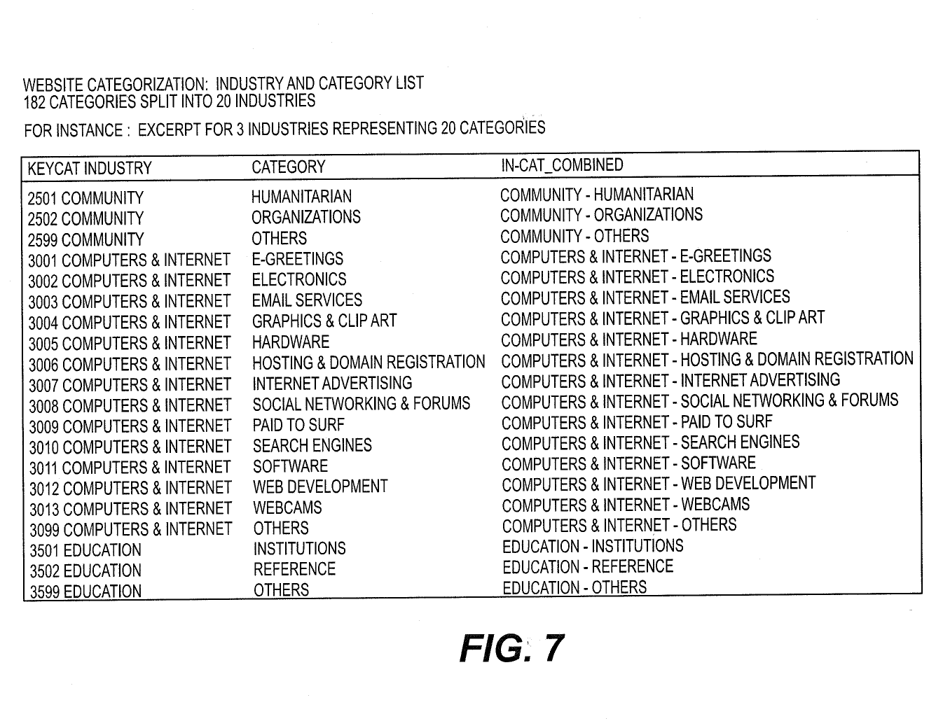

FIG. 7 is a graphical depiction, in tabular form, of an excerpt taken from the industry and category list scheme employed in the website categorization process depicted in FIG. 6;

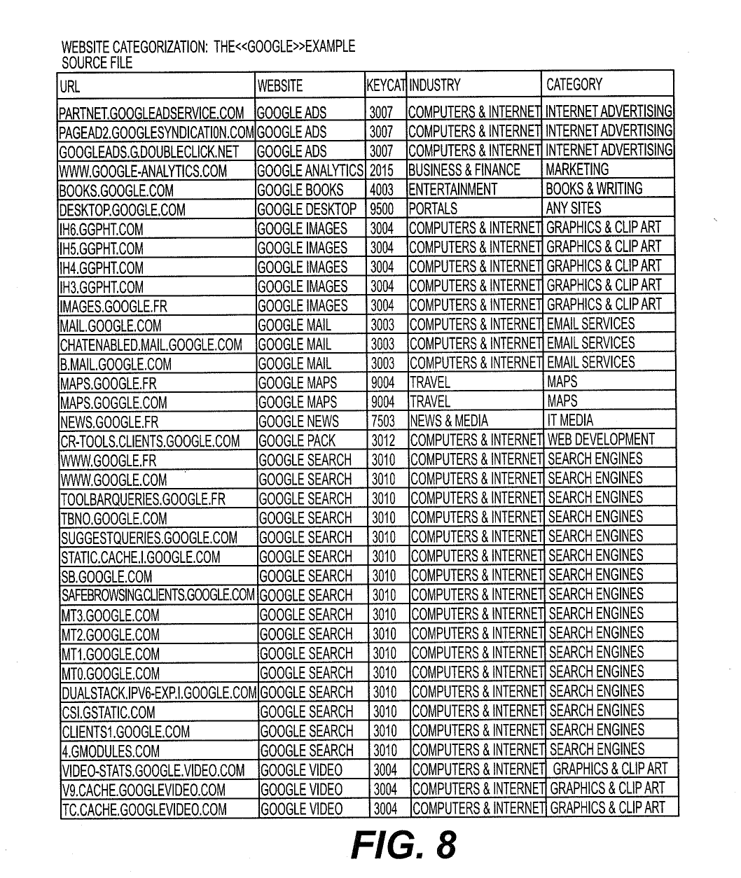

FIG. 8 is a graphical depiction, in tabular form, of an illustrative form of website categorization that correlates URLs from an exemplary domain to an industry and category;

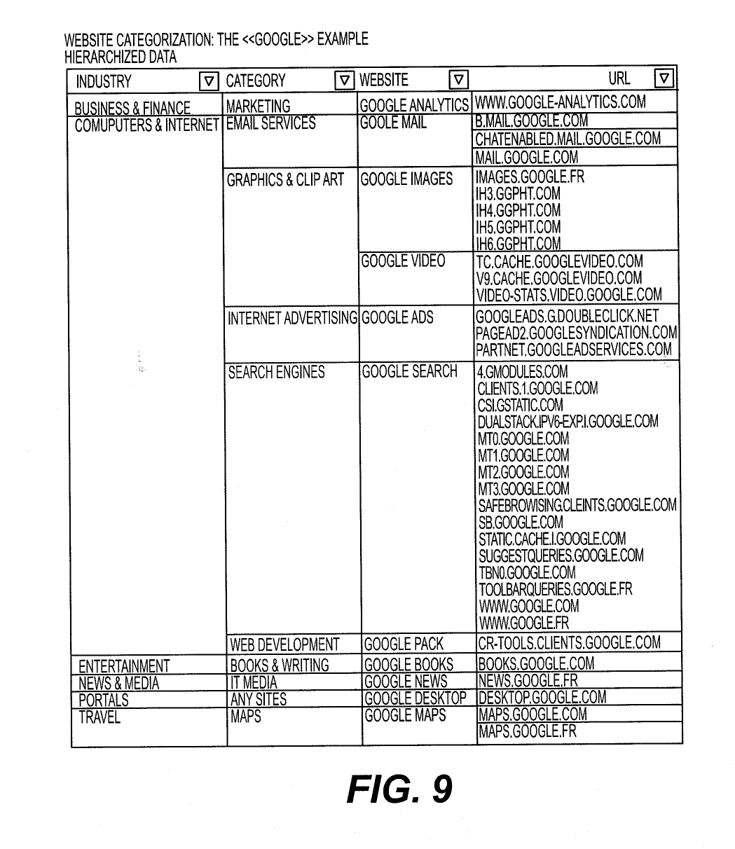

FIG. 9 is a graphical depiction, in a tabular form, of a hierarchical form of website categorization in accordance with an illustrative aspect of the present invention;

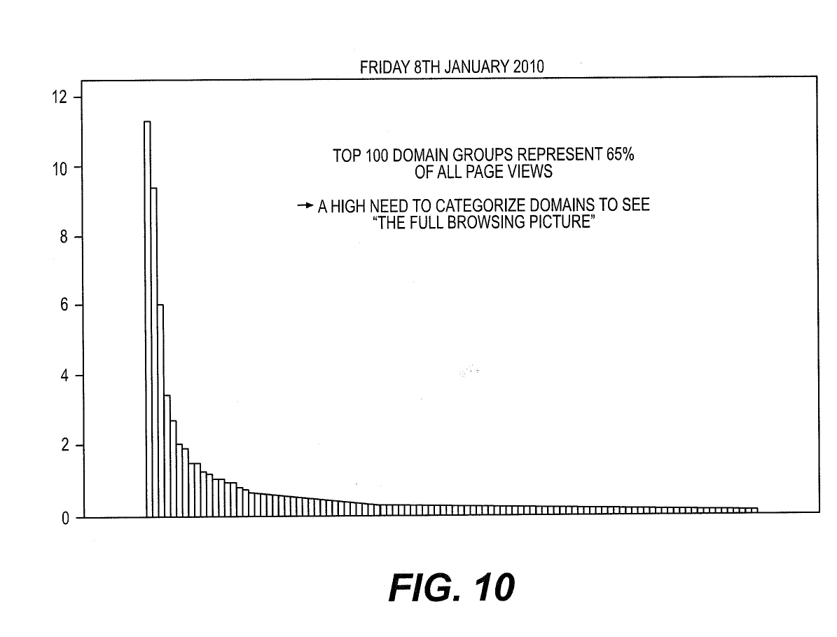

FIG. 10 is a graph depicting an illustrative distribution of discrete domain groups visited by unique subscribers of at least one communication network on a specified date, the respective share of each visited domain group as a percentage of the overall visited domain groups being shown in descending order;

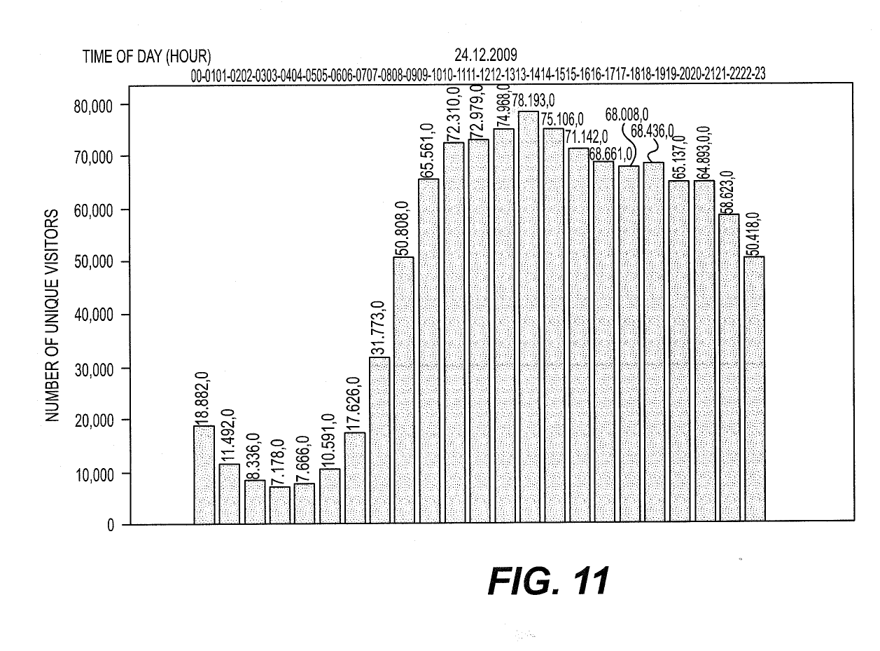

FIG. 11 is a graph depicting, during each hour of a specified day, an illustrative number of unique visitors to a specified website;

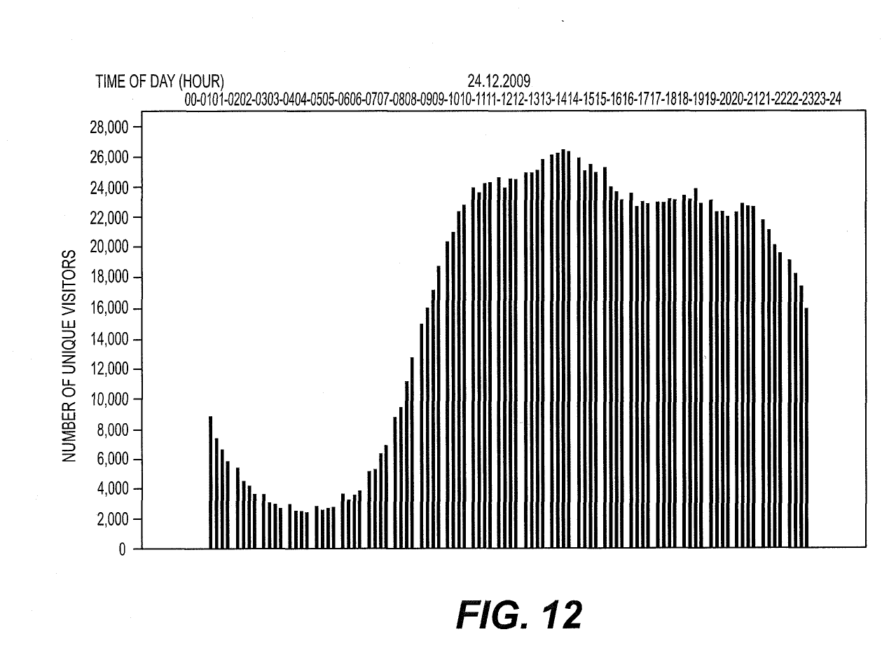

FIG. 12 is a graph depicting the same information as FIG. 11, only with each hour broken down into quarter-hour increments for enhanced granularity;

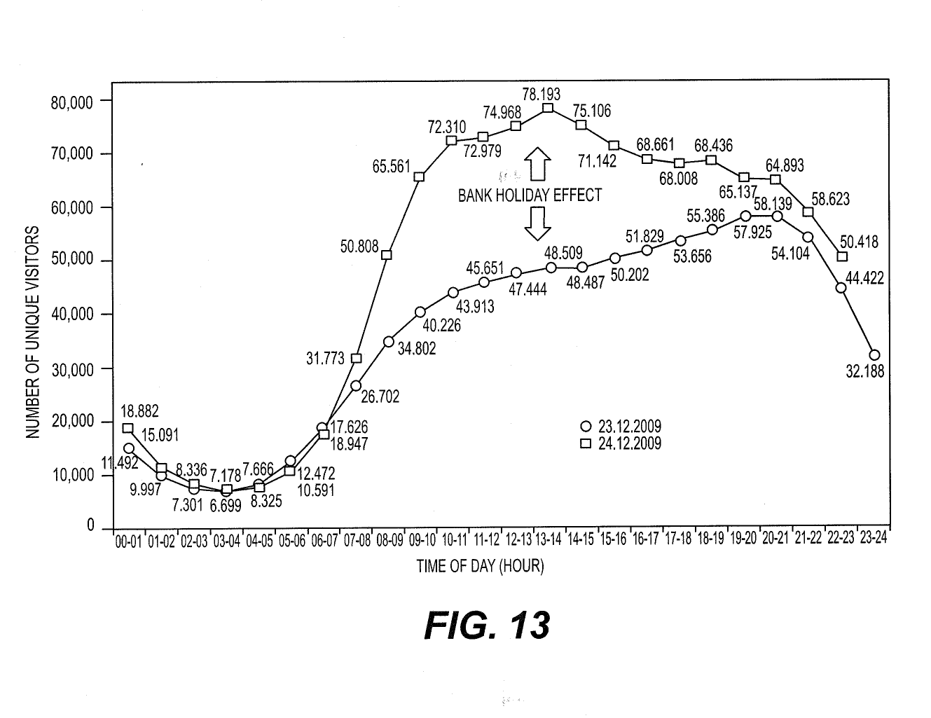

FIG. 13 is a graph depicting, for the same website specified in FIGS. 11 and 12 and for each hour of the same specified day, the number of unique visitors;

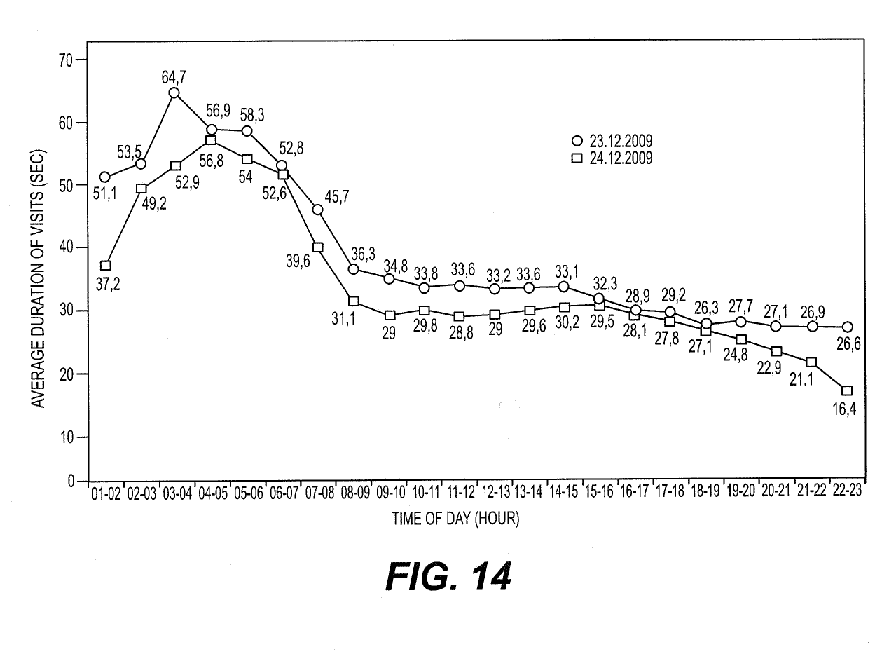

FIG. 14 is a graph depicting, during each hour of a specified day, the average duration of each visit by unique subscribers to a specified website; and

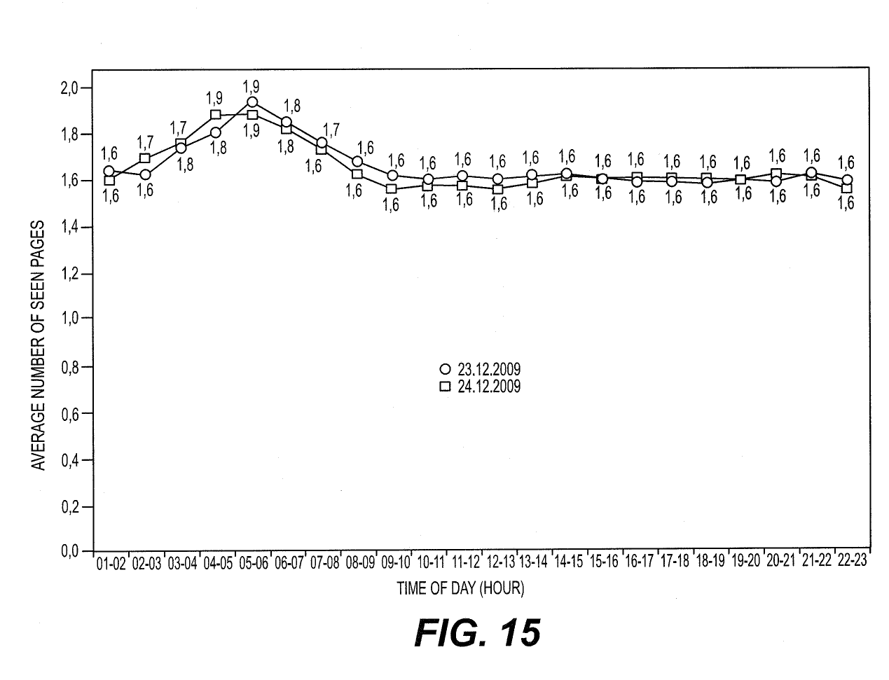

FIG. 15 is a graph depicting, during each hour of a specified day, the average number of a specified web page was visited by unique subscribers.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

With initial reference to FIG. 1A, there is shown a system 100 for performing the anonymized collection of internet access and behavioral activity data from different types of communication networks such, for example, as one more mobile communication networks—as represented by mobile communication network 200 operated by a first mobile communication network operator—and one or more fixed-based internet service providers—as, for example, represented by DSL access network 300 operated as a conventional internet service provider (ISP) network.

“ISP” as used herein includes any entity providing Internet connectivity and bandwidth to fixed devices. As such, an ISP may comprise a traditional retail internet service provider, a corporate network, an upstream provider, and an MSO, among others. The term “mobile communication network operator” includes any service provider whose subscribers communicate over radio-frequency channels using a fixed or portable messaging device. Examples of portable messaging devices include 3G mobile terminals, smart phones, and personal digital assistants. A notebook computer equipped with a wireless interface can be deemed either a fixed or a portable messaging device, depending upon the subscriber's pattern of use.

Mobile communications networks are especially preferred because each mobile terminal device has a unique identification number that identifies one and only subscriber. Certain additional socio-demographic data which may or may not be beyond that normally maintained as part of the mobile network operator's billing records can be conveniently collected by the network operator from its subscribers to form a socio-demographic profile for some or all users. By way of illustrative example, the socio-demographic data might include the age, gender, household and/or personal income, and the like. As will be described in greater detail later, all such personal information is preferably safeguarded by an anonymization process that associates a unique identifier to the socio-demographic data before it is sent to system 100 for storage and analysis. Naturally, no information from which the personal identity of the subscriber can be derived is sent to or stored by system 100.

A generic architecture is shown in FIG. 1A for mobile communication network 200, which can map to either GSM or CDMA technologies. Mobile terminal devices, as PDA device 202, smart phone device 204, mobile card-equipped notebook computer device 206, connect through base stations, as base station 208 to the IP-based GPRS/UMTS mobile network data core 212 via a Service GPRS Support Node (SGSN) and router Gateway GPRS Support Node (GGSN) 214. The GGSN is in a GSM network. In a CDMA network, the devices connect through a PDSN/HA. In case the network is based on simple IP, there may not be a HA but just a PDSN. The mobile data request may be sent to content and application servers outside the mobile network 200 (this is often referred to in the industry as “off deck” or “off net”) or to an operator portal via a WAP gateway (neither of which are shown).

The data request may also be to application servers (not shown) which may be internal or external to the operator. The data at the output of the GGSN 214 thus comprises all types of data applications, including Web, WAP, video, audio, messaging, downloads, and other traffic. In addition, the mobile data network has an authorization, authentication and accounting (AAA) server 216, a Customer Relationship Management (CRM) database (not shown), and a Home Location Register (HLR) 218 to manage subscriber information. Other types of data sources might include a Short Messaging Service Center (SMSC) (not shown) to manage messaging traffic. It should be noted that although conventional SMS traffic is typically conveyed on the signaling channel of GSM networks, operators are now migrating to SMS over IP due to the high volume of SMS traffic. Thus, although the description herein is directed to the processing and analysis of http traffic, such is intended to be by way of illustration only and it should be emphasized that anonymized processing and analysis of SMS traffic—with reference to socio-demographic and/or behavior factors—is also within the scope of the teachings herein.

Insofar as the inventors herein contemplate that the anonymized data collection and analysis platform 100 of the present invention may be used to aggregate data from subscribers across multiple communication networks of the same or different types, an additional mobile network indicated generally at reference numeral 230 is shown in FIG. 1. Additionally, conventional internet service provider (ISP) network 300 is representative of the one or more additional data communication networks—providing internet access to subscribers using fixed terminals, as for example, personal computer device 302 and enhanced VoIP telephony device 304—from which data collection and analysis platform 100 of the present invention may collect internet access activity data correlated to corresponding unique subscribers.

With continued reference to FIG. 1A, it will be seen that ISP network 300 includes a broadband remote server (BRAS) 306 which routes traffic to and from digital subscriber line access multiplexers (DSLAMs) as DSLAM 308. As will be readily appreciated by those skilled in the art, the BRAS sits at the core of an ISP's network where it routes traffic into the network backbone. BRAS 306 also aggregates user sessions from the access network. It is at BRAS 306 that the ISP injects policy management and IP Quality of Service. Other conventional elements of the ISP include e-mail server 310, an IP-PBX 312 to support VoIP devices as VoIP phone 304, an ftp server 314, and an AAA server.

An IP address does not uniquely and reliably identify a particular person within a given household, and it may even be re-assigned each time an access device as personal computer connects to ISP network 300 via the well known Dynamic Host Control Protocol (DHCP). Thus, in order to collect activity relating to unique subscribers of ISP network 300, it may be desirable to employ a client side support application (e.g., cookies, or JavaScript applets) to collect a log of the web sites visited by the individual subscribers, and to uniquely identify a user who has voluntarily agreed to become a virtual panelist. Alternatively, additional information may be collected from the AAA or DHCP server that allocates the IP addresses to subscribers (and thus typically has access to some form of permanent subscriber identifier). In any event, and in accordance with an illustrative embodiment of the present invention, each volunteer will provide the same type of socio-demographic information as described above, and this information will be stored in an ISP database.

With continuing reference to the illustrative embodiment of FIG. 1A, it will be seen that system 100 includes a first anonymized network data collection system 102 which receives a duplicate of the traffic traversing GGSN 214 and a second anonymized network data collection system 103 which receives a duplicate of the packetized traffic traversing BRAS 306. Essentially, collection systems 102 and 103 perform extraction of raw network access data such, for example, as internet usage and/or access data from received IP packets using a conventional deep packet inspection technique. The extracted raw network access data may include, for example, the URLs of web sites and web pages visited by individual subscribers, the date and time each packet was transmitted or received, and the unique identifier that is used by each network operator to associate the packet with one of its subscribers. For regulatory and/or privacy reasons, the extraction process is within the sole control of the network operator(s). As such, no entity other than the network operator has access to any network operator records which would associate the identity of a subscriber to any of the extracted data. In accordance with a preferred embodiment of the invention, this is achieved by forwarding the extracted raw network access data to a probe 120 (FIG. 3) which, in a manner to be described shortly, anonymizes the raw network access data and performs role management functions in order to ensure that only anonymized network access data can be retrieved for transfer to storage, processing, analysis and reporting platform 104. Platform 104 may be operated by the network operator or by an entity other than the network operator. The latter arrangement is preferred since it makes it possible to gather network access data from multiple operators and thereby obtain a much more comprehensive view of activity within a given territory or region.

Any anonymized network access data that is retrieved and transferred to platform 104 is identified by a unique identifier from which the personal identity of any individual subscriber can not be derived is forwarded to or stored by platform 104. As a result, the administrator and users of platform 104 can neither identify any individual subscriber nor direct any advertisements or any other messages to any individual or group of individuals by virtue of accessing the information stored at platform 104.

Referring now to FIG. 1B, there is shown in greater detail the anonymized data storage, analysis, tracking, and reporting platform 104 utilized by the illustrative embodiment of the present invention depicted in FIG. 1A. FIG. 1C is a block schematic diagram illustrating an arrangement of databases and firewalls for controlling the exchange of information between one or more communication networks and the anonymized data collection and analysis platform.

FIGS. 2A, 2B, 2C and 3 depict the interoperation of anonymized network data collection system 102 and platform 104, with particular emphasis on the manner in which the anonymization is performed. With particular reference to FIG. 2A, it will be seen that via a conventional tap and a mirror port on the GGSN of the mobile network 200 (not shown), a duplicate traffic flow is developed and forwarded to probe 120. Deep packet inspection is then performed on the data stream, in a conventional manner, which exposes the contents of each packet so that, for example, internet access data (websites and web pages visited, the duration of such visits, and date and time of each visit), as well as certain information unique to the particular subscriber who is the sender or recipient of the packet. In the illustrative example of a mobile communication network, the unique information includes the mobile network identifier (MSISDN) assigned to each subscriber by the mobile network operator. The purpose of probe 120 is to perform role management, providing a third party (an entity other than the network operator) with limited access.

Using a secret key known only to the mobile operator, the mobile network identifier (MSISDN) of the subscriber is encrypted so as to be irretrievably lost to the operator of platform 104. As such, the internet access data (websites and web pages visited, as well as the duration of such visits, and their date and time) is associated not with the user's MSISDN or IP address but with the encrypted, unique ID. A buffer server indicated generally at reference numeral 122 receives the thus-anonymized data and forwards this to a database 124 of platform 104. Probe 120 and buffer server 122 are remotely monitored at workstation 126, permitting visualization of the raw anonymized data. The information stored within database 124 is analyzed and aggregated to generate a variety of useful reports, some or all of which may be accessed via an online portal indicated generally at 128.

Turning now to FIGS. 4A-4D there are shown exemplary methods of performing anonymized internet activity data collection, storage, analysis and reporting in accordance with the teachings of the present invention. With initial reference to FIG. 4A, it will be seen an illustrative process is entered at step 402. At step 402, packetized traffic associated with each of N subscribers of a mobile communication network accessing the internet using a mobile terminal is monitored to extract the user identifier (e.g., the MSISDN number) and raw network access data corresponding to that MSISDN number. To maintain the privacy of each user, the user identifier is encrypted (step 404). An exemplary encryption technique is a hashing algorithm using a secret key, and results in the creation of an anonymized unique identifier from which the identity of the associated user can not be readily determined without access to the secret key. At step 406, the anonymized identifier is correlated to the raw network access data to create anonymized user network access data. On the basis of the anonymized identifier, a particular messaging device user's anonymized user network access data such, for example, as the URL addresses of web pages or web pages visited by that user can be distinguished from the anonymized user network access data associated with any other messaging device user. In the embodiment of FIG. 4A, the correlated data is stored (step 408). A third party may then request (step 409) access to the anonymized data, and after an authentication process (step 410), the third party may be granted access to retrieve the correlated data for subsequent processing and analysis.

In the modified embodiment of FIG. 4B, the anonymized unique identifier obtained at step 404 is also correlated (step 407) to a socio-demographic profile that includes such information as the age, gender, state or country of residence, household income level, education level, and any other socio-demographic characteristic which might provide insight into patterns of internet browsing and/or purchasing activity. At step 411, both the anonymized user access data and the anonymized socio-demographic profiles are stored, processed and analyzed (step 414) to generate reports (step 416) which, as will be explained in greater detail later, identify patterns of internet browsing, brand awareness and online purchasing activity.

In the modified embodiment of FIG. 4C, it is contemplated that the communication network provider will collect socio-demographic data from some or all of its users that have agreed to allow reference to such data provided it is appropriately anonymized. At step 401, the socio-demographic data is obtained from some or all subscribers. At step 403, each profile is correlated to a corresponding unique identifier (e.g., MSISDN) —preferably using the same encryption algorithm and secret key as employed to anonymize the network access data. The correlated, anonymized profiles are stored at step 405. When the network operator receives a third party request to access the data contained in the anonymized profiles (step 418), a conventional authentication process (step 420) is performed and authorization to permit retrieval of the profiles is granted at step 422, whereupon a third party can perform a detailed analysis of the anonymized network access data that takes into account the socio-demographic characteristics of the messaging device users. The advantages of this arrangement will soon become readily apparent to those skilled in the art.

In the embodiment of FIG. 4D, the process is entered at step 450. At step 450, anonymized user network access data are retrieved from a first communication operator which may be, for example, a first mobile communication network operator providing services to a first group of mobile terminal users. At step 452, anonymized user network access data are retrieved from a second communication network operator which may be, for example, a second mobile communication network operator providing services to a second group of mobile terminal users. At step 454, the retrieved network access data is correlated to anonymized unique identifiers furnished by the respective operators, by which the internet browsing activity of said first and second groups of mobile terminal users can be individually but anonymously tracked. At step 456, socio-demographic data is obtained from panelists recruited from among some of the users belonging to the first and/or second group of mobile terminal users. The socio-demographic data is anonymized by correlating (step 458) each respective profile to the corresponding user's anonymized, unique identifier. Step 458 is performed by the operator. In the mobile network example, the anonymized unique identifier may be requested from the applicable network operator after identifying the users comprising one or more panels. Such a request may be achieved by providing to the network operator the MSISDN of the panelists. The process may also be automated using an online authentication and data entry procedure (not shown). At step 462, the anonymized network access data is processed and analyzed with our without reference to the socio-demographic data of the panelists in accordance with the particular type of report to be generated (step 464).

FIG. 5 is a block diagram illustrating the tracking of the various phases comprising an online shopping experience, from brand awareness to shopping cart checkout, which can be tracked and analyzed in accordance with an aspect of the present invention. The awareness phase, depicted generally at block 502 is characterized by visits to particular websites, where the consumer can discover a product or a service or a brand (creation of “awareness”) as represented by block 504, where one or more advertisement banners are displayed on the screen to the user (block 505). This initial “advertising impression”, in the most desired case, is followed by the “brand image creation process”, indicated at block 506, which normally occurs as the result of clicking (block 508) on an advertisement banner (block 510) and is reinforced during the next phase, characterized as the “product information” gathering phase, wherein the user gathers product information (block 512) by searching information through queries on search engines (block 514) to review information on particular products services or brands (block 516). The intention-to-buy phase (block 518) is signified by beginning the purchasing process of filling an on-line shopping basket (block 520) via an e-commerce portal (block 522). The last phase, or final event, is the consummation of the purchase by an online-checkout (block 524). While the actual purchase transaction data is fully encrypted and therefore not available through the monitoring process employed by the present invention, it is contemplated by the inventors herein that a third party which has enrolled a representative number of voluntary panelists in the manner described previously will have access to the shopping cart transaction data, should analysis of the latter be required.

FIG. 6 is a block diagram depicting the categorization of websites in accordance with a further illustrative aspect of the present invention, the categorization serving as a preliminary step to a form of internet access activity aggregation that makes possible, for example, the reporting and analysis of general trends applicable to one or more specifiable socio-demographic groups. It will be seen by reference to FIG. 6, that examining a particular instance of internet activity by a uniquely identified subscriber will reveal the URL address of the web page visited. From the URL, the Sub-Domain Name, Domain Name, Domain Group, and Domain Owner can all be derived the corresponding web objects consist of the web page, web site selection, website and website owner, respectively. Categorization, in accordance with the present invention, seeks to classify each discrete visit by a unique user in ways that might be useful, for example, when the behavior of users in a particular socio-demographic group is aggregated together to spot patterns, recognized trends, or make a particular observation. In the example presented in FIG. 6, the type of site visited (e.g., mobile), its category (broadcast media), and its industry/family (publishing/information) can all be ascertained. Aggregated together, such information could be used to generate reports of interest to an entire category of merchants, manufacturers and advertisers, rather than merely to a single content provider.

A further example of categorization is presented in Table I, which is directed to a series of URLs associated with the Swedish domain group “aftonbladet”.

TABLE I

| URL | Domain Group | Site Type | Category Number | Main Category | Industry/Family |
|---|---|---|---|---|---|
| mobile.aftonbladet.se | aftonbladet | mobile | 6019 | Publishing/Information | Print |
| www.aftonbladet.se | aftonbladet | standard | 6019 | Publishing/Information | Print |
| vader.aftonbladet.se | aftonbladet | standard | 6019 | Publishing/Information | Print |
| afton.aftonbladet.se | aftonbladet | standard | 6019 | Publishing/Information | Print |

FIG. 7 is a graphical depiction, in tabular form, of an excerpt taken from the industry and category list scheme employed in the website categorization process depicted in FIG. 6, while FIG. 8 is a graphical depiction, in tabular form, of an illustrative form of website categorization that correlates URLs from an exemplary domain to an industry and category. FIG. 9 is a graphical depiction, in a tabular form, of a hierarchical form of website categorization in accordance with an illustrative aspect of the present invention. By reference to Tables I, II and III, it will become readily appreciated to those skilled in the art why the application of a system of categorization in accordance with the teachings of the present invention can be a very valuable tool.

TABLE II

| Main | No. of Web | | Number of |
|---|---|---|---|
| Industry Category | Pages Visited | Industry/Family | Pages Seen |
| Not Yet Coded | 17,333,945 | | |
| Social Networking & | 7,595,856 | | |
| Forums | | | |
| Portal | 4,046,952 | | |
| Professional Services | 1,327,565 | | |
| Non-identifiable | 1,021,278 | | |
| Publishing/Information | 827,561 | | |
| Shopping/Orders | 558,197 | | |
| Online Entertainment | 608,203 | Games | 414,197 |
| | | Television | 97,117 |
| | | Radio | 66,838 |
| | | Gambling/Betting | 30,017 |
| | | Movies | 33 |
| Manufacturers | 183,621 | | |
| Adult | 115,173 | | |
| Travel | 27,351 | | |
| Finance/Property | 4,385 | | |

TABLE III

| | | Number | | |
|---|---|---|---|---|
| | | of Web | Number | |
| | | Pages | of Unique | Avg. Duration of Web |
| Sub-Industry Category | # of Visits | Visited | Visitors | Page Visits (sec) |
| Online Entertainment - Games | 45,155 | 115,057 | 2,153 | 44.5 |
| Online Entertainment - Gambling | 5,905 | 9,330 | 1,374 | 25.5 |
| Online Entertainment - Television | 16,191 | 33,161 | 2,975 | 65.6 |
| Online Entertainment - Radio | 7,263 | 11,361 | 1,231 | 187.9 |
| Online Entertainment - Books & Writing | | | | |

TABLE IV

| | % Internet Access Activity in Category (by Age) - Friday, Jan. 8, 2010 | | | | | |
|---|---|---|---|---|---|---|
| Sub-Industry Category | 17-18 | 18-19 | 19-20 | 20-21 | 21-22 | 22-23 |
| Online Entertainment - Games | 60.4% | 59.3% | 55.4% | 60.1% | 63.3% | 67.5% |
| Online Entertainment - Gambling | 5.8% | 9.9% | 11.5% | 6.7% | 7.3% | 4.5% |
| Online Entertainment - Television | 23.1% | 20.1% | 23.8% | 24.4% | 19.5% | 18.4% |
| Online Entertainment - Radio | 10.7% | 10.8% | 9.2% | 8.7% | 9.6% | 9.6% |
| Online Entertainment - Books & Writing | ND | ND | ND | ND | ND | ND |

FIG. 10 is a graph depicting an illustrative application of the categorization and identification of domain groups in accordance with the present invention. FIG. 10 depicts the type of report that can be generated to show the distribution of discrete domain groups visited by unique subscribers of at least one communication network on a specified date. The respective share of each visited domain group—as a percentage of the overall visited domain groups—is shown in descending order. In this example, the top one hundred domain groups visited by the anonymously tracked subscribers represented 65% of all web pages visited. Such a long “tail” demonstrated a need to categorize the domains to see “the full browsing picture”.

FIG. 11 is a graph depicting, during each hour of a specified day, an illustrative number of unique visitors to a specified website. FIG. 12 is a graph depicting the same information as FIG. 11, only with each hour broken down into quarter-hour increments for enhanced granularity. FIG. 13 is a graph depicting, for the same website specified in FIGS. 11 and 12 and for each hour of the same specified day, the number of unique visitors. FIG. 14 is a graph depicting, during each hour of a specified day, the average duration of each visit by unique subscribers to a specified website. FIG. 15 is a graph depicting, during each hour of a specified day, the average number of visits to a specified web page by uniquely identifiable users. The foregoing examples are intended to exemplify the variety of reports which can be generated using the inventive system and methods of collection, analysis, categorization and reporting disclosed herein.

While the specific details are provided for operating this system in a mobile network, the approach is in no way limited to a mobile network. The same analytical methodologies described herein can be applied to include other networks, including broadband cable, DSL, WiMAX, and other networks. Equivalent information can be extracted from similar sources of data and similar analytics can be applied to mine the collected data.

While the above describes a particular order of operations performed by a given embodiment of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While given components of the system have been described separately, one of ordinary skill also will appreciate that some of the functions may be combined or shared in given instructions, program sequences, code portions, and the like. The invention being thus described, it will be obvious that the same may be varied in many ways. Such variations are not to be regarded as a departure from the spirit and scope of the invention, and all such modifications as would be obvious to one skilled in the art are to be included within the scope of the following claims).

What is claimed is:

1. A method for collecting and analyzing Internet and electronic commerce data, comprising the steps of:
monitoring packet traffic of a communication system providing communication services to a plurality of messaging devices, each respective messaging device corresponding to a unique user of the communication system, wherein said monitoring includes performing deep packet inspection to extract network data from packet traffic associated with respective users of the communication system;
encrypting a portion of network data extracted from individual packets to obscure information from which an identity of a user might otherwise be determined, thereby obtaining an anonymized, unique identifier and corresponding anonymized network access data associated with respective users of the communication system; and
granting a third party access to anonymized network access data, associated with identifiably unique but anonymous users of the communication system, for storage in a third party database, whereby stored network access data associated with each respective user of the communication system is distinguishable from stored network access data associated with every other user of the communication system based on the unique identifier.

2. The method of claim 1, wherein said step of granting access includes authorizing the third party to retrieve the group of anonymized unique identifiers and corresponding anonymized network access data for storage in the third party database.

3. The method of claim 2, wherein said step of granting access further includes a step of authenticating the third party prior to authorizing the third party to retrieve the group of anonymized unique identifiers and corresponding anonymized network access data.

4. The method of claim 1, wherein the communication system includes a mobile communication network operated by a network operator providing messaging services to N users of mobile terminals, wherein each mobile terminal correlates to a unique mobile identifier extractable from monitored packets to thereby enable the network operator to identify each user of the mobile communication network, and wherein each mobile identifier extracted from a monitored packet is encrypted by the network operator to obtain a corresponding anonymized, unique identifier.

5. The method of claim 4, further including a step of temporarily storing anonymized unique identifiers and corresponding anonymized network access data, whereby stored network access data associated with any one of said N users is distinguishable from network access data associated with any other of said N users.

6. The method of claim 5, further including a step of authenticating the third party prior to grant access to the temporarily stored, anonymized unique identifiers and corresponding anonymized network access data.

7. The method of claim 5, wherein authorization to retrieve temporarily stored anonymized unique identifiers and corresponding anonymized network access data is provided during the step of granting access.

8. The method of claim 7, further including a step of sharing an anonymized unique identifier corresponding to a voluntary panel participant, whereby the third party may distinguish anonymized network access data associated with the first voluntary panel participant from anonymized network access data associated with any other of the N users and whereby the third party may correlate demographic data obtained from the first voluntary panel participant with anonymized network access data associated with the first voluntary panel participant.

9. The method of claim 8, wherein the temporarily stored anonymized network access data includes at least one of each website visited by said N users of mobile terminals during a time interval and each web page visited by said N users during a time interval.

10. The method of claim 4, wherein the anonymized network access data includes an indication of at least one of each website visited by said N users of mobile terminals during a time interval and an identification of each web page visited by said N users during a time interval.

11. The method of claim 4, wherein said step of encrypting includes deriving each anonymized, unique identifier from a corresponding unique mobile identifier using a cryptographic hash function and private key not known to the third party.

12. The method of claim 1, wherein anonymized network access data includes an indication of at least one of each website visited by users of messaging devices during a time interval and an identification of each web page visited by said N users of messaging devices during a time interval.

13. A method for collecting and analyzing Internet and electronic commerce data, comprising the steps of:
monitoring packet traffic of a communication system providing communication services to a plurality of messaging devices, each respective messaging device corresponding to a unique user of the communication system, wherein said monitoring includes performing deep packet inspection to extract network data from packet traffic associated with respective users of the communication system;
encrypting a portion of network data extracted from individual packets to obtain an anonymized, unique identifier and correspondingly anonymized network access data associated with respective users of the communication system; and
storing anonymized network access data, associated with identifiably unique but anonymous users of the communication system, in a database, whereby stored network access data associated with each respective user of the communication system is distinguishable from stored network access data associated with every other user of the communication system based on the anonymized, unique identifier.

14. The method of claim 13, wherein the communication system includes a mobile communication network operated by a network operator providing messaging services to N users of mobile terminals, wherein each mobile terminal correlates to a unique mobile identifier extractable from monitored packets to thereby enable the network operator to identify each user of the mobile communication network, and wherein each mobile identifier extracted from a monitored packet is encrypted by a third party operated probe using a secret key not known to the third party to obtain a corresponding anonymized, unique identifier, the third party having only limited access comprising at least one of an ability to view anonymized raw data processed by the probe and to download anonymized data from the probe.

15. The method of claim 14, wherein the anonymized network access data includes an indication of at least one of each website visited by said N users of mobile terminals during a time interval and an identification of each web page visited by said N users during a time interval.

16. The method of claim 14, wherein said step of encrypting includes deriving each anonymized, unique identifier from a corresponding unique mobile identifier using a cryptographic hash function in combination with a secret key not known to the third party.

17. The method of claim 16, wherein the secret key is stored on an operator-controlled root user account of the probe, the third party not having authorization to access or request the secret key nor any un-anonymized data.

18. The method of claim 14, further including a step of associating, with each of M users of the mobile communication network, a socio-demographic profile including at least one of a subscriber's age, gender, mobile service plan, mobile terminal model, household income, and residence, wherein M is an integer equal to or less than N and consisting of users who have agreed to permit anonymized collection and analysis of their network access activity and whereby network access activity of those of said M users sharing at least one selectable demographic characteristic is distinguishable from network access activity of those of said M users who do not share the at least one selectable demographic characteristic and all of said N users who have not agreed to provide socio-demographic information.

19. The method of claim 13, further including a step of analyzing the stored network access data to obtain internet access data including, for each anonymously tracked user, at least one of a history of all web pages visited, a duration of each web page visit, an identity of all advertisements presented on each web page, an image of all advertisements presented on each website, an identity of web pages visited in response to clicking on an advertisement, and a list of brand names of products purchased online.

20. The method of claim 13, further including a step analyzing the stored network access data to measure how many anonymously tracked users at least one of were exposed to a displayed advertisement and clicked on an advertisement to which they were exposed during a defined interval of time.

21. The method of claim 20, further including a step of generating a report graphically depicting a plurality of measurements, each respective measurement corresponding to a number of anonymously tracked users exposed to a displayed ad during a corresponding interval of time.

22. The method of claim 20, further including a step of generating a report graphically depicting a plurality of measurements, each respective measurement corresponding to a number of anonymously tracked users clicking on an advertisement during a corresponding interval of time.

23. The method of claim 13, wherein anonymized network access data includes an indication of at least one of each website visited by said users of messaging devices during a time interval and each web page visited by said users of messaging devices during a time interval.

24. The method of claim 13, further including a step of sharing an anonymized unique identifier corresponding to a voluntary panel participant, whereby the third party may distinguish anonymized network access data associated with the first voluntary panel participant from anonymized network access data associated with any other of the N users and whereby the third party may correlate demographic data obtained from the first voluntary panel participant with anonymized network access data associated with the first voluntary panel participant.

25. A method for collecting and analyzing Internet and electronic commerce data, comprising the steps of:
monitoring packet traffic of a communication system providing communication services to a plurality of messaging devices, each respective messaging device corresponding to a unique user of the communication system, wherein said monitoring includes performing deep packet inspection to extract network data from packet traffic associated with respective users of the communication system;
obtaining an anonymized, unique identifier and corresponding anonymized network access data associated with respective users of the communication system; and
granting a third party access to anonymized network access data, associated with identifiably unique but anonymous users of the communication system, for storage in a third party database, whereby stored network access data associated with each respective user of the communication system is distinguishable from stored network access data associated with every other user of the communication system based on the unique identifier.

26. The method of claim 25, wherein said step of granting access includes authorizing the third party to retrieve a group of anonymized unique identifiers and corresponding anonymized network access data for storage in the third party database.

27. The method of claim 26, wherein said step of granting access further includes a step of authenticating the third party prior to authorizing the third party to retrieve the group of anonymized unique identifiers and corresponding anonymized network access data.

28. The method of claim 25, wherein the communication system includes a mobile communication network operated by a network operator providing messaging services to N users of mobile terminals, wherein each mobile terminal correlates to a unique mobile identifier extractable from monitored packets to thereby enable the network operator to identify each user of the mobile communication network, and wherein each mobile identifier extracted from a monitored packet is encrypted by the network operator to obtain a corresponding anonymized, unique identifier.

29. The method of claim 28, further including a step of temporarily storing anonymized unique identifiers and corresponding anonymized network access data, whereby stored network access data associated with any one of said N users is distinguishable from network access data associated with any other of said N users.

30. The method of claim 28, wherein the anonymized network access data includes an indication of at least one of each website visited by said N users of mobile terminals during a time interval and an identification of each web page visited by said N users during a time interval.

31. The method of claim 28, wherein said step of encrypting includes deriving each anonymized, unique identifier from a corresponding unique mobile identifier using a cryptographic hash function and private key not known to the third party.

32. The method of claim 1, wherein anonymized network access data includes an indication of at least one of each website visited by users of messaging devices during a time interval and an identification of each web page visited by said N users of messaging devices during a time interval.
